(19) United States
(12) Patent Application Publication
(10) Pub. No.: US 2026/0194638 A1
(43) Pub. Date: Jul. 9, 2026

(54) SPATIALLY DISTRIBUTED DEPTH SENSOR ARRAY

(71) Applicant: GM GLOBAL TECHNOLOGY OPERATIONS LLC, Detroit, MI (US)

(72) Inventors: James Foresi, Bloomfield Hills, MI (US); Julien P. Mourou, Bloomfield Hills, MI (US)

(21) Appl. No.: 19/009,071

(22) Filed: Jan. 3, 2025

(51) Int. Cl. G01S 7/4865; G01B 11/22; G01S 7/481; G01S 17/894; G01S 17/931

(52) U.S. Cl. CPC G01S 7/4865; G01B 11/22; G01S 7/4814; G01S 7/4816; G01S 17/894; G01S 17/931

(57) ABSTRACT

Aspects of the disclosure include a spatially distributed depth sensor array for vehicle sensing. An exemplary spatially distributed depth sensor array includes a 1 by N array of unit cells. Each unit cell includes a receive pixel having at least one single photon avalanche photodiode (SPAD) vertically stacked over at least one time-to-digital converter (TDC), a transmit pixel having at least one vertical cavity surface emitting laser (VCSEL), and a backplane. The receive pixel and the transmit pixel are integrated onto a surface of the backplane to define a respective unit cell. The backplane is configured to receive time-of-flight (TOF) signals from the at least one SPAD responsive to detection of a photon emitted from the at least one VCSEL.

### INTRODUCTION

The present disclosure relates to vehicle sensing equipment and depth sensors, and particularly to a spatially distributed depth sensor array.

Vehicle sensing equipment encompasses a wide range of technologies designed to enhance the safety, efficiency, and autonomy of modern vehicles. These systems include cameras, radar, ultrasonic sensors, and depth sensors such as lidar, each serving specific functions to detect and interpret a vehicle's surroundings. By providing real-time data on the environment and vehicle, these sensors enable advanced driver assistance systems (ADAS) and autonomous driving capabilities.

Depth sensors, in particular, play a crucial role in vehicle sensing by providing accurate distance measurements to objects around a vehicle. Light Detection and Ranging (LiDAR) is one of the most commonly used depth sensing technologies. LiDAR works by emitting laser pulses and measuring the time it takes for the reflected light to return to the sensor. This time-of-flight measurement allows the sensor system to create a detailed map of the objects and environment around the vehicle, which is essential for tasks such as obstacle detection, collision avoidance, and navigation.

### SUMMARY

In one exemplary embodiment a vehicle includes a body and a depth sensing system. The depth sensing system includes one or more spatially distributed depth sensor arrays distributed along or integrated into the body, each of the one or more spatially distributed depth sensor arrays defined by a 1 by N array of unit cells. Each unit cell includes a receive pixel having at least one single photon avalanche photodiode (SPAD) vertically stacked over at least one time-to-digital converter (TDC), a transmit pixel having at least one vertical cavity surface emitting laser (VCSEL), and a backplane. The receive pixel and the transmit pixel are integrated onto a surface of the backplane to define a respective unit cell. The backplane is configured to receive time-of-flight (TOF) signals from the at least one SPAD responsive to detection of a photon emitted from the at least one VCSEL.

In some embodiments, each unit cell includes a short-range depth sensor having a range of less than 15 meters.

In some embodiments, each unit cell further includes a field of view of at least 180 degrees and an angular resolution of less than 1 degree.

In some embodiments, each unit cell further includes a field of view of 180 degrees and an angular resolution of 0.3 degrees.

In some embodiments, a first spatially distributed depth sensor array and a second spatially distributed depth sensor array have a different number of unit cells.

In some embodiments, a first spatially distributed depth sensor array is distributed along the body in a first direction and a second spatially distributed depth sensor array is distributed along the body in a second direction orthogonal to the first direction.

In some embodiments, N is at least 360 and each unit cell includes an angular resolution of less than or equal to one degree.

In one exemplary embodiment a spatially distributed depth sensor array includes a 1 by N array of unit cells. Each unit cell includes a receive pixel having at least one single photon avalanche photodiode (SPAD) vertically stacked over at least one time-to-digital converter (TDC), a transmit pixel having at least one vertical cavity surface emitting laser (VCSEL), and a backplane. The receive pixel and the transmit pixel are integrated onto a surface of the backplane to define a respective unit cell. The backplane is configured to receive time-of-flight (TOF) signals from the at least one SPAD responsive to detection of a photon emitted from the at least one VCSEL.

In some embodiments, each unit cell includes a short-range depth sensor having a range of less than 15 meters.

In some embodiments, each unit cell further includes a field of view of at least 180 degrees and an angular resolution of less than 1 degree.

In some embodiments, each unit cell further includes a field of view of 180 degrees and an angular resolution of 0.3 degrees.

In some embodiments, a first subset of the unit cells has a first centerline-to-centerline pitch, and a second subset of the unit cells has a second centerline-to-centerline pitch.

In some embodiments, the first centerline-to-centerline pitch is between 1 and 10 mm.

In some embodiments, N is at least 360 and each unit cell includes an angular resolution of less than or equal to one degree.

In yet another exemplary embodiment a method can include forming a spatially distributed depth sensor array. The method can include forming a plurality of single photon avalanche photodiodes (SPADs) on a first wafer, forming a plurality of time-to-digital converters (TDCs) on a second wafer, and forming a plurality of vertical cavity surface emitting lasers (VCSELs) on a third wafer. The method can include singulating the SPADs, TDCs, and VCSELs. The method can include assembling, on a shared backplane, a plurality of unit cells in a 1×N array. Each unit cell can include a receive pixel having at least one SPAD vertically stacked over at least one TDC and a transmit pixel having at least one VCSEL.

In some embodiments, each unit cell includes a short-range depth sensor having a range of less than 15 meters.

In some embodiments, each unit cell further includes a field of view of at least 180 degrees and an angular resolution of less than 1 degree.

In some embodiments, a first subset of the unit cells has a first centerline-to-centerline pitch, and a second subset of the unit cells has a second centerline-to-centerline pitch.

In some embodiments, the first centerline-to-centerline pitch is between 1 and 10 mm.

In some embodiments, N is at least 360 and each unit cell includes an angular resolution of less than or equal to one degree.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured with spatially distributed depth sensor arrays in accordance with one or more embodiments;

FIG. 2 is a unit cell of a spatially distributed depth sensor array in accordance with one or more embodiments;

FIG. 3 is an example modular microassembly manufacturing process for spatially distributed depth sensor arrays in accordance with one or more embodiments;

FIG. 4. is a computer system according to one or more embodiments; and

FIG. 5 is a flowchart in accordance with one or more embodiments.

### DETAILED DESCRIPTION

The following description is merely exemplary in nature and is not intended to limit the present disclosure, its application or uses.

Vehicle sensing systems often rely on a suite of sensors to provide a range of sensing capabilities. For example, vehicles can be equipped with radar, ultrasonic sensors, cameras, infrared sensors, accelerometers, gyroscopes, etc., which can be used together or separately to provide a comprehensive understanding of a vehicle's environment. Depth sensors, in particular, can play a crucial role in vehicle sensing by providing accurate distance measurements to objects around a vehicle. One of the most common types of depth sensor is the Light Detection and Ranging (LiDAR) system. LiDAR sensors emit laser pulses and measure the time it takes for reflected light to return to the sensor. This time-of-flight measurement allows the system to create a detailed map of the environment. LiDAR is known for providing relatively high resolutions and accuracy, making these systems well-suited to tasks such as obstacle detection, collision avoidance, and navigation.

Unfortunately, current LiDAR solutions for short-range depth sensing are somewhat limited. For example, LiDAR is typically configured as a solid-state system or as a scanning system. Solid-state lidar systems use electronic components without any moving parts to emit laser pulses and detect reflected light. These systems rely on techniques such as optical phased arrays, microelectromechanical systems (MEMS), or flash lidar to steer the laser beam and capture depth information. Scanning lidar systems, on the other hand, use mechanical components to physically move the laser beam across the environment. This can be achieved through rotating mirrors, oscillating mirrors, or other mechanical scanning mechanisms. However, each of these systems face practical limitations in their implementation, such as coverage gaps when implemented on real vehicles.

To illustrate, consider how the typical field of view (FOV) of a LiDAR system (that is, the angular extent over which the system can detect and measure objects) will necessarily result in coverage gaps around a real vehicle. Coverage gaps occur when there are areas within a desired sensing range that the LiDAR system cannot detect or measure. LiDAR FOV is a parameter that determines how much of the surrounding environment the lidar can “see” at any given time. The FOV is typically described in terms of horizontal and vertical angles, such as 360 degrees horizontally and 30 degrees vertically. Coverage gaps can arise due to several factors related to the FOV of a LiDAR system.

First, traditional LiDAR systems may have a natively limited FOV, meaning they cannot cover the entire area around the vehicle. For example, a LiDAR with a 120-degree horizontal FOV will leave blind spots on either side of the vehicle, resulting in coverage gaps. These gaps can be problematic for autonomous vehicles and driver-assist systems, as they may miss detecting obstacles or other important features in the environment. Some LiDAR configurations are designed to protrude from the vehicle's body to increase the FOV, but this solution impacts vehicle styling and aerodynamics. In addition, even if a LiDAR system has an arbitrarily wide FOV (even up to 360 degrees), its resolution may not be sufficient to provide detailed coverage of the entire area. High-resolution LiDAR systems can capture more detailed information, but they still face practical limitations in short-range applications (that is, at ranges below 15 meters) where a relatively high angular resolution is desired (e.g., angular resolutions below 3 degrees). In such cases, LiDAR may not be able to detect small or closely spaced objects, leading to coverage gaps within the stated FOV. Moreover, physical obstructions, such as parts of the vehicle itself or other objects in the environment, can block a LiDAR's line of sight within the operational FOV, creating coverage gaps irrespective of the stated FOV or resolution. For example, a roof-mounted 360-degree FOV LiDAR may have difficulty detecting objects close to a vehicle's sides or underneath overhangs, while a side-mounted 120-degree LiDAR will leave coverage gaps along regions of the vehicle that are adjacent to the LiDAR. These limitations highlight the need for more efficient and flexible depth sensing solutions that can be seamlessly integrated into vehicle designs without compromising performance or aesthetics.

This disclosure introduces a spatially distributed depth sensor array for sensing applications. Rather than relying upon traditionally mounted LiDAR sensors with relatively high FOVs (e.g., 120-degree FOV, 180-degree FOV, 360-degree FOV, etc.) and relatively low angular resolutions (e.g., above 1 degree), the spatially distributed depth sensor array described herein employs a relatively large number of depth sensors having angular resolutions below 1 degree (e.g., 0.5 degrees). Each individual sensor in the array consists of a single photon avalanche photodiode (SPAD), time-to-digital converter (TDC), and vertical cavity surface emitting laser (VCSEL).

In this configuration, the VCSELs provide an illumination source, the SPADs detect reflected illumination emitted by the VCSELs from a scene around a vehicle, and the TDCs calculate a distance that corresponds to a round-trip time from the VCSEL to the SPAD. In some embodiments, the components can be attached to a back-plane using, for example, microassembly techniques. The backplane can provide power to the sensors and aggregates signals from the sensors for use by downstream perception and/or safety systems. The number of sensors in the array and the spacing between the sensors in the array can be modified as desired to meet the requirements of a given application. In other words, the spatially distributed depth sensor array described herein can be thought of as a flexible array of laser range finders that can be spaced appropriately to achieve any desired angular resolution around a vehicle. The spatially distributed depth sensor array described herein can be configured as a complete replacement for more traditional LiDAR systems, or alternatively, as a supplemental depth sensing system for more traditional LiDAR systems. For example, a spatially distributed depth sensor array can be positioned to fill the coverage gaps of a traditional LiDAR system, or to provide improved angular resolution or one or more specific regions of an environment of a vehicle served via a traditional LiDAR system (e.g., blind spots, direct front of vehicle, rear of vehicle, etc.). Moreover, the spatially distributed depth sensor array can be manufactured as a flexible strip that can be flexibly integrated around a vehicle in a manner that respects styling features (e.g., along trimlines, wheel wells, etc.).

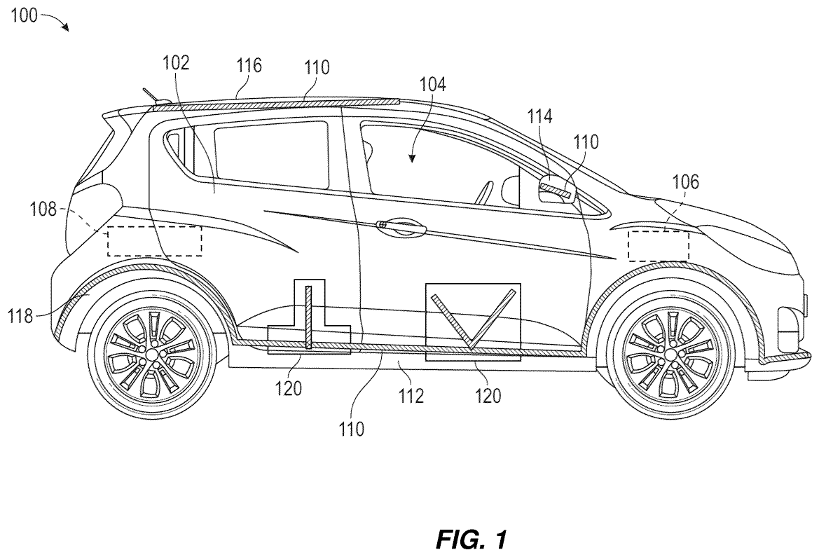

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure. In some embodiments, the electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of an electric vehicle, but this is only an illustrative embodiment. The type of vehicle (e.g., electric, combustion, hydrogen fuel cell, etc.) is not meant to be particularly limited.

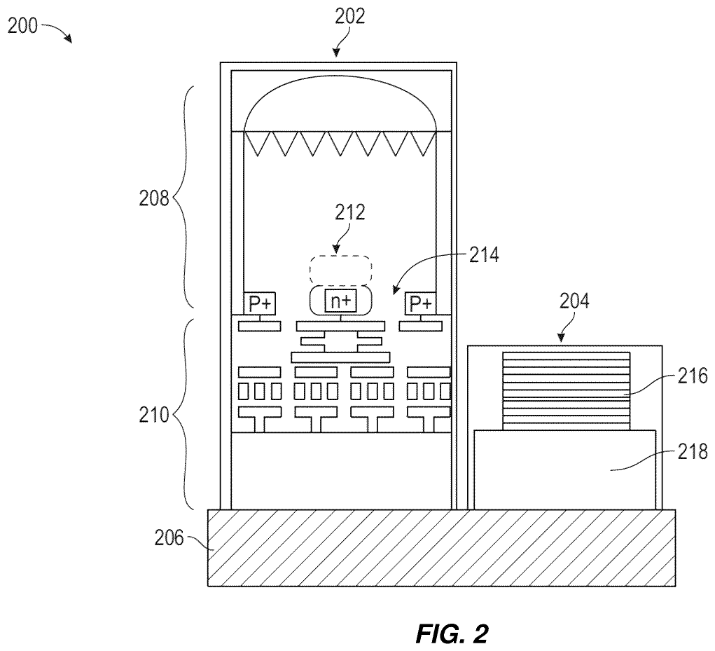

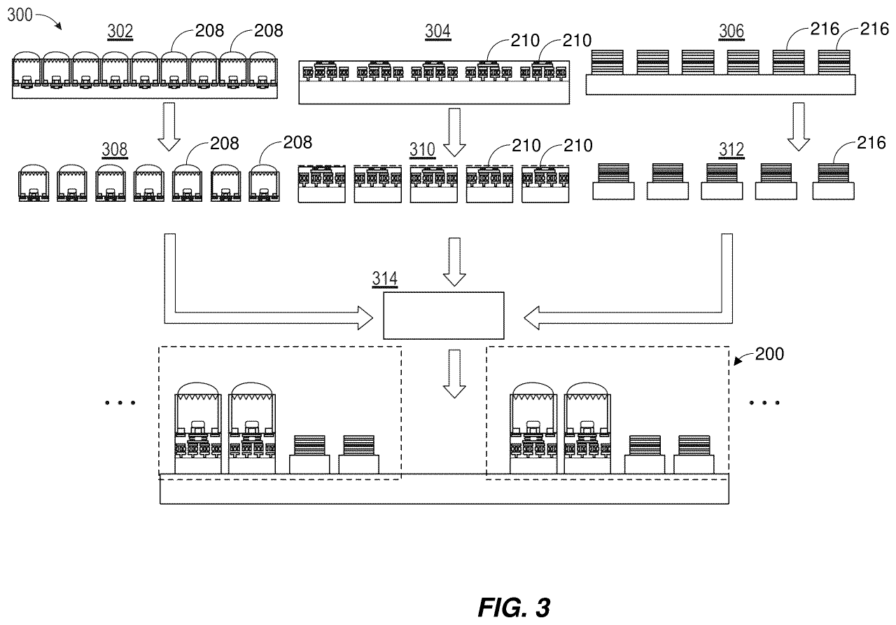

In some embodiments, vehicle 100 is equipped with one or more spatially distributed depth sensor arrays 110. In some embodiments, a spatially distributed depth sensor array 110 includes N individual unit cells 200 (refer to FIG. 2), where each unit cell 200 is a single sensor of the N sensors in the overall array. The total number of sensors N in a spatially distributed depth sensor array 110 need not be particularly limited. Advantageously, due to a modular microassembly manufacturing process described herein (refer to FIG. 3), the spatially distributed depth sensor arrays 110 can be manufactured to have any number of unit cells 200 (that is, N can be arbitrarily defined for each application). In some embodiments, such so those desiring 360-degree coverage, the spatially distributed depth sensor array 110 includes at least 360 individual unit cells 200 (e.g., N is at least 360). For example, to achieve 0.3 degree resolution over a 360 degree FOV with unit cells 200 offering 0.3 degree resolutions would require 1200 unit cells 200. A 180 degree FOV with the same sensors would require 600 unit cells 200.

Notably, the spacing between adjacent unit cells 200 need not be symmetric throughout the spatially distributed depth sensor array 110. For example, the array density (centerline-to-centerline pitch) of the unit cells 200 can be relatively high in some areas and relatively low in other areas of vehicle 100. This allows the spatially distributed depth sensor arrays 110 to distribute unit cells 200 in a targeted matter (perhaps, for example, to allow for increased sensor coverage in areas which are the most underserved by current LiDAR systems).

In some embodiments, each of the spatially distributed depth sensor arrays 110 includes a 1 by N (1×N) array of unit cells 200. The unit cells 200 are discussed in greater detail with respect to FIG. 2. In some embodiments, the spatially distributed depth sensor arrays 110 are integrated within or onto the body 102 of the vehicle 100. In some embodiments, the spatially distributed depth sensor arrays 110 are configured as 1×N strips that can be run along any region of interest on the vehicle 100, such as, for example, along a trim 112 of the vehicle 100, along a side mirror 114 of the vehicle 100, along a roof 116 of the vehicle 100, along a wheel well 118 of the vehicle 100, etc. These configurations themselves are merely illustrative, and other locations are possible and within the contemplated scope of this disclosure. In some embodiments, two or more of the spatially distributed depth sensor arrays 110 can be configured to provide three-dimensional coverage in any desired orientation, such as, for example, by running a first spatially distributed depth sensor array 110 orthogonal to a second spatially distributed depth sensor array 110. These types of configurations are shown in the sensor regions 120 of the vehicle 100.

In any case, the spatially distributed depth sensor arrays 110 provide a near-range depth sensing capability that is easily integrated into vehicle 100. The spatially distributed depth sensor arrays 110 can be used to provide depth sensing coverage in any area of vehicle 100, such as areas where traditional sensors have coverage gaps. In some embodiments, spatially distributed depth sensor arrays 110 can be configured to provide depth sensing coverage around the entirety of vehicle 100. Either configuration (or a combination of the approaches) can be used to provide an alternative from the integration of individual lidar units, which can provide advantages with respect to power consumption, size, styling impacts, and ease of manufacture.

FIG. 2 illustrates an example unit cell 200 of a spatially distributed depth sensor array 110 (refer to FIG. 1) in accordance with one or more embodiments. As shown in FIG. 2, a unit cell 200 includes one or more receive pixels 202 and one or more transmit pixels 204 on a shared backplane 206. In some embodiments, a unit cell 200 includes a single receive pixel 202 and a single transmit pixel 204 on the shared backplane 206 (as shown). In some embodiments, each unit cell 200 includes two or more (e.g., 2, 3, 4, 10, 20, etc.) receive pixels 202 and two or more (e.g., 2, 3, 4, 10, 20, etc.) transmit pixels 204 on the shared backplane 206 (not separately shown).

In some embodiments, each receive pixel 202 includes a photon avalanche photodiode (SPAD) 208 vertically stacked over a time-to-digital converter (TDC) 210. In some embodiments, SPAD 208 includes a depletion region 212 (also referred to as the “avalanche region”) formed at a P-N junction or a P-I-N junction 214. P-N and P-I-N junctions are semiconductor structures that consist of two or three layers. The P-type layer is the region of the underlying semiconductor that is doped with acceptor impurities, such as boron, to create an abundance of holes (positive charge carriers). This layer is referred to as “p-type” because it has a higher concentration of holes compared to electrons. In contrast, the N-type layer is the region of the underlying semiconductor that is doped with donor impurities, such as phosphorus, to create an abundance of electrons (negative charge carriers). This layer is referred to as “n-type” because it has a higher concentration of electrons compared to holes. Finally, the I-layer, or intrinsic layer, is the middle region of a P-I-N junction and is made of undoped or very lightly doped semiconductor material. This layer is referred to as “intrinsic” because it is relatively pure of dopants and has no significant concentration of charge carriers (neither electrons nor holes). The intrinsic layer acts as a depletion region, where an electric field is established when the P-I-N junction is biased. In some embodiments, SPAD 208 can also include a quenching circuit (not separately indicated) to stop or “quench” the avalanche current after a photon detection event, allowing the SPAD 208 to reset and be ready for the next photon detection event.

In some embodiments, SPAD 208 operates in a Geiger mode, where the SPAD 208 is biased above a known breakdown voltage. In this mode, the SPAD 208 is highly sensitive to incoming photons. When a photon strikes the SPAD 208, the interaction results in the generation of an electron-hole pair. This pair is then accelerated by the high electric field present in the depletion region 212, leading to an avalanche multiplication process. This avalanche results in a large current pulse, the detection of which can be passed through the TDC 210 and into the backplane 206 (as well as further downstream systems). In this manner, a single photon event can be easily detected and counted.

TDCs measure a time interval between two events by converting the time difference into a digital value. The basic principle involves counting the number of clock cycles or using a delay line to measure the time interval with high precision. In some embodiments, TDC 210 can be used in conjunction with the SPAD 208 and transmit pixel 204 by measuring the time interval between the emission of a laser pulse by a Vertical Cavity Surface Emitting Laser (VCSEL) 216 of the transmit pixel 204 and the detection of the reflected photon by the SPAD 208. This time interval, also referred to as time-of-flight (TOF), is then used to calculate the distance to the object from which the photon reflected, enabling accurate depth sensing along the path of the laser pulse. In some embodiments, TDC 210 converts the time interval into a digital output that represents the measured time interval, which itself can be passed to and processed by any number of downstream systems.

While not meant to be particularly limited, the TDC 210 can include, for example, start and stop inputs, a clock generator, a counter, a delay line, an interpolator, and digital logic (these internal components are not separately indicated). Start and stop inputs receive the signals that mark the beginning and end of the time interval to be measured. In the context of the unit cell 200, the start signal is generated when the VCSEL 216 emits a laser pulse, and the stop signal is generated when the SPAD 208 detects the reflected photon. A clock generator provides a high-frequency clock signal that can be used to measure a time interval. The resolution of the TDC 210 is determined by the frequency of the clock signal; higher clock frequencies result in finer time resolution. The counter, if present, counts the number of clock cycles that occur between the start and stop signals. The resultant count value represents a coarse measurement of the time interval. In some embodiments, TDC 210 includes a delay line to achieve a finer time resolution. The delay line can include a series of delay elements, each introducing a small, known delay. The time interval can then be measured by determining how far the signal propagates through the delay line before the stop signal is received. An interpolator provides additional precision by measuring the fraction of the clock cycle at the start and stop events. This allows the TDC 210 to achieve sub-clock cycle resolutions. Finally, the digital logic processes the outputs from the counter, delay line, and interpolator to generate a final digital value representing the measured time interval.

In some embodiments, each transmit pixel 204 includes a VCSEL 216 vertically stacked over a substrate 218. A vertical cavity surface emitting laser is a type of semiconductor laser diode that emits light perpendicular to the surface of the underlying substrate, as opposed to edge-emitting lasers that emit light from the side. In the context of the unit cell 200, the VCSEL 216 is used as the illumination source in the transmit pixel 204. That is, the VCSEL 216 is configured to emit photons, typically in a laser pulse of known duration.

While not meant to be particularly limited, VCSEL 216 can include, for example, an active region, a distributed Bragg reflector (DBR), a cavity, and a current injector (these internal components are not separately indicated). The active region is where light generation occurs and can include multiple quantum wells (MQWs) made of semiconductor materials such as gallium arsenide (GaAs) or indium phosphide (InP). In some embodiments, the quantum wells are sandwiched between layers of different semiconductor materials to form a heterostructure, which enhances the efficiency of light emission. In some embodiments, VCSEL 216 uses one or more DBRs as mirrors to form a laser cavity. DBRs are made of alternating layers of materials with different refractive indices, creating a highly reflective mirror. In some embodiments, VCSEL 216 includes a top DBR and a bottom DBR. In some embodiments, the top DBR is partially reflective, allowing some light to escape as the laser output, while the bottom DBR is highly reflective, ensuring that most of the light is confined within the laser cavity. The cavity itself can be designed for a predetermined cavity length, typically on the order of a few micrometers. This relatively short cavity length allows for single longitudinal mode operation, resulting in a narrow linewidth and stable output wavelengths. Electrical current can be injected into the active region through metal contacts in substrate 218. This current injection provides the necessary carriers (electrons and holes) for the recombination process in the quantum wells, leading to the generation of photons.

FIG. 3 illustrates an example modular microassembly manufacturing process 300 for fabricating spatially distributed depth sensor arrays 110 in accordance with one or more embodiments. As shown in FIG. 3, process 300 begins with steps 302, 304, and 306, which can be completed in parallel or sequentially, as desired.

At step 302, SPADs 208 (also referred to as SPAD pixels) are formed on a wafer using, for example, semiconductor processing techniques such as photolithography. More specifically, step 302 can involve a number of wafer preparation and patterning processes. During these processes, a wafer, typically silicon, is cleaned, oxidized, doped, and patterned to provide an arbitrarily large number of SPADs (the number is only limited by the wafer size, and the size of each SPAD pixel). In some embodiments, the wafer undergoes doping to create the p-type and n-type regions required for the SPAD structure. Doping introduces specific impurities into the silicon to modify its electrical properties. For example, boron may be used to create p-type regions, while phosphorus may be used for n-type regions. The doping process can be performed using ion implantation and/or diffusion techniques, as desired. Substructures of each of the SPADs can be defined using photolithography. These processes typically include the application of a photoresist layer over the wafer, and a photomask with a desired pattern is aligned over the wafer. The wafer can then exposed to a light source, such as ultraviolet (UV) light, to transfer the pattern from the photomask to the photoresist. The exposed photoresist can then be developed, leaving behind the patterned areas. Metal contacts are deposited on the wafer to provide electrical connections to the p-type and n-type regions of the SPAD pixels. This is typically done using a process called sputtering or evaporation, followed by photolithography and etching to define the contact patterns. The metal contacts allow for the application of bias voltage and the extraction of the output signal from the SPAD pixels.

At steps 304 and 306, similar semiconductor processing techniques can be used to define, respectively a number of digital logic integrated circuits and a number of VCSELs 216. In some embodiments, the digital logic integrated circuits are TDCs 210.

At steps 308, 310, and 312, the respective wafers are diced into individual, or singulated, dies, chips, and pixels. Dicing can completed using various fabrication processes, such as, for example, via a die saw or laser singulation.

At step 314, the singulated SPADs 208 (refer to steps 302 and 308), singulated TDCs 210 (refer to steps 304 and 310), and singulated VCSELs 216 (refer to steps 306 and 312) are integrated into a final device (a unit cell 200 of a spatially distributed depth sensor array 110). In some embodiments, SPADs 208 are vertically stacked over TDCs 210 to define receive pixels 202, which are placed adjacent to VCSELs 216 that define transmit pixels 204. In some embodiments, the receive pixels 202 and transmit pixels 204 are then assembled onto a common backplane 206. Step 314 can be repeated as desired to form a spatially distributed depth sensor array 110 having any number of unit cells 200.

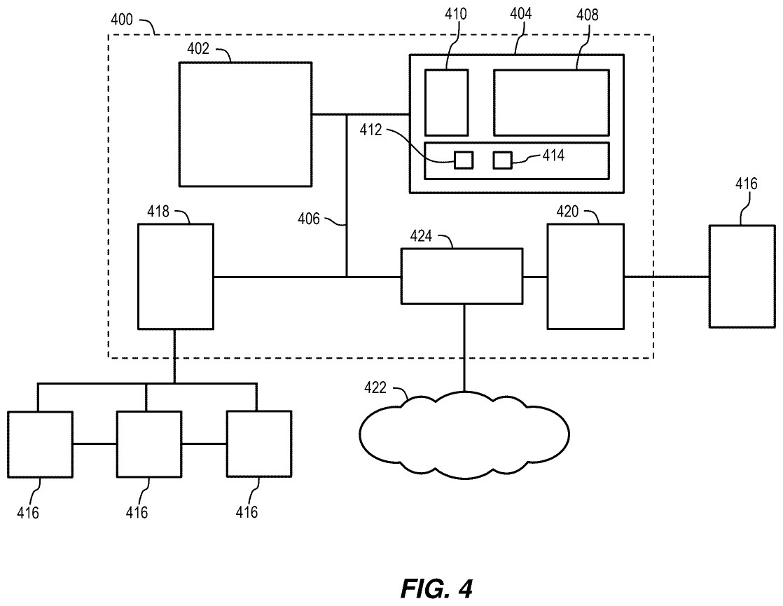

FIG. 4 illustrates aspects of an embodiment of a computer system 400 that can perform various aspects of embodiments described herein. In some embodiments, the computer system(s) 400 can implement and/or otherwise be incorporated within or in combination with a spatially distributed depth sensor array 110 (refer to FIG. 1) having one or more unit cells 200 (refer to FIG. 2) fabricated using a modular microassembly manufacturing process (refer to FIG. 3). For example, in some embodiments, computer system 400 can apply or receive a signal (e.g., voltage, current, etc.) to or from the unit cell 200, such as via a control signal to VCSEL 216 to emit light, or via a data signal received from backplane 206 containing TOF data from a photon detection event of the SPAD 208 as timed by the TDC 210.

The computer system 400 includes at least one processing device 402, which generally includes one or more processors or processing units for performing a variety of functions, such as, for example, any and/or all of the functions described previously herein. Components of the computer system 400 also include a system memory 404, and a bus 406 that couples various system components including the system memory 404 to the processing device 402. The system memory 404 may include a variety of computer system readable media. Such media can be any available media that is accessible by the processing device 402, and includes both volatile and non-volatile media, and removable and non-removable media. For example, the system memory 404 includes a non-volatile memory 408 such as a hard drive, and may also include a volatile memory 410, such as random access memory (RAM) and/or cache memory. The computer system 400 can further include other removable/non-removable, volatile/non-volatile computer system storage media.

The system memory 404 can include at least one program product having a set (e.g., at least one) of program modules that are configured to carry out functions of the embodiments described herein. For example, the system memory 404 stores various program modules that generally carry out the functions and/or methodologies of embodiments described herein. A module or modules 412, 414 may be included to perform functions related to any of the block diagrams described herein. The computer system 400 is not so limited, as other modules may be included depending on the desired functionality of the computer system 400. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 402 can also be configured to communicate with one or more external devices 416 such as, for example, a keyboard, a pointing device, and/or any devices (e.g., a network card, a modem, etc.) that enable the processing device 402 to communicate with one or more other computing devices. Communication with various devices can occur via Input/Output (I/O) interfaces 418 and 420.

The processing device 402 may also communicate with one or more networks 422 such as a local area network (LAN), a general wide area network (WAN), a bus network and/or a public network (e.g., the Internet) via a network adapter 424. In some embodiments, the network adapter 424 is or includes an optical network adaptor for communication over an optical network. It should be understood that although not shown, other hardware and/or software components may be used in conjunction with the computer system 400. Examples include, but are not limited to, microcode, device drivers, redundant processing units, external disk drive arrays, RAID systems, and data archival storage systems, etc.

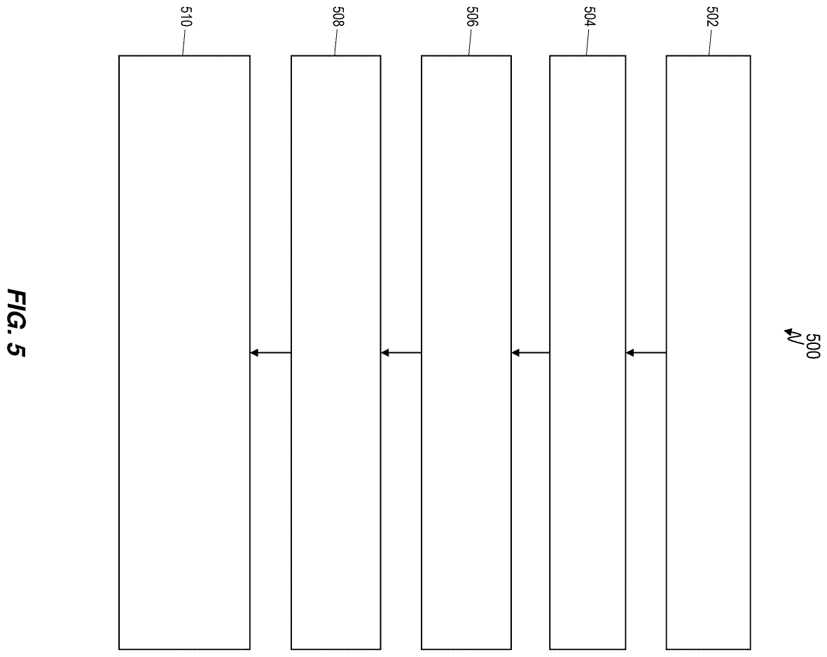

Referring now to FIG. 5, a flowchart 500 for leveraging a spatially distributed depth sensor arrays 110 for depth sensing is generally shown according to an embodiment. The flowchart 500 is described in reference to FIGS. 1-4 and may include additional steps not depicted in FIG. 5. Although depicted in a particular order, the blocks depicted in FIG. 5 can be rearranged, subdivided, and/or combined.

At block 502, the method includes forming a plurality of single photon avalanche photodiodes (SPADs) on a first wafer.

At block 504, the method includes forming a plurality of time-to-digital converters (TDCs) on a second wafer.

At block 506, the method includes forming a plurality of vertical cavity surface emitting lasers (VCSELs) on a third wafer.

At block 508, the method includes singulating the SPADs, TDCs, and VCSELs.

At block 510, the method includes assembling, on a shared backplane, a plurality of unit cells in a 1×N array. Each unit cell can include a receive pixel having at least one SPAD vertically stacked over at least one TDC and a transmit pixel having at least one VCSEL.

In some embodiments, each unit cell includes a short-range depth sensor having a range of less than 15 meters.

In some embodiments, each unit cell further includes a field of view of at least 180 degrees and an angular resolution of less than 1 degree.

In some embodiments, a first subset of the unit cells has a first centerline-to-centerline pitch, and a second subset of the unit cells has a second centerline-to-centerline pitch.

In some embodiments, the first centerline-to-centerline pitch is between 1 and 10 mm.

In some embodiments, N is at least 360 and each unit cell includes an angular resolution of less than or equal to one degree.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
a body; and
a depth sensing system, the depth sensing system comprising one or more spatially distributed depth sensor arrays distributed along or integrated into the body, each of the one or more spatially distributed depth sensor arrays comprising a 1 by N array of unit cells, each unit cell comprising:
a receive pixel comprising at least one single photon avalanche photodiode (SPAD) vertically stacked over at least one time-to-digital converter (TDC);
a transmit pixel comprising at least one vertical cavity surface emitting laser (VCSEL); and
a backplane;
wherein the receive pixel and the transmit pixel are integrated onto a surface of the backplane to define a respective unit cell; and
wherein the backplane is configured to receive time-of-flight (TOF) signals from the at least one SPAD responsive to detection of a photon emitted from the at least one VCSEL.

2. The vehicle of claim 1, wherein each unit cell comprises a short-range depth sensor having a range of less than 15 meters.

3. The vehicle of claim 2, wherein each unit cell further comprises a field of view of at least 180 degrees and an angular resolution of less than 1 degree.

4. The vehicle of claim 3, wherein each unit cell further comprises a field of view of 180 degrees and an angular resolution of 0.3 degrees.

5. The vehicle of claim 1, wherein a first spatially distributed depth sensor array and a second spatially distributed depth sensor array have a different number of unit cells.

6. The vehicle of claim 1, wherein a first spatially distributed depth sensor array is distributed along the body in a first direction and a second spatially distributed depth sensor array is distributed along the body in a second direction orthogonal to the first direction.

7. The vehicle of claim 1, wherein N is at least 360 and each unit cell comprises an angular resolution of less than or equal to one degree.

8. A spatially distributed depth sensor array comprising:
a 1 by N array of unit cells, each unit cell comprising:
a receive pixel comprising at least one single photon avalanche photodiode (SPAD) vertically stacked over at least one time-to-digital converter (TDC);
a transmit pixel comprising at least one vertical cavity surface emitting laser (VCSEL); and
a backplane;
wherein the receive pixel and the transmit pixel are integrated onto a surface of the backplane to define a respective unit cell; and
wherein the backplane is configured to receive time-of-flight (TOF) signals from the at least one SPAD responsive to detection of a photon emitted from the at least one VCSEL.

9. The spatially distributed depth sensor array of claim 8, wherein each unit cell comprises a short-range depth sensor having a range of less than 15 meters.

10. The spatially distributed depth sensor array of claim 9, wherein each unit cell further comprises a field of view of at least 180 degrees and an angular resolution of less than 1 degree.

11. The spatially distributed depth sensor array of claim 10, wherein each unit cell further comprises a field of view of 180 degrees and an angular resolution of 0.3 degrees.

12. The spatially distributed depth sensor array of claim 8, wherein a first subset of the unit cells has a first centerline-to-centerline pitch, and a second subset of the unit cells has a second centerline-to-centerline pitch.

13. The spatially distributed depth sensor array of claim 12, wherein the first centerline-to-centerline pitch is between 1 and 10 mm.

14. The spatially distributed depth sensor array of claim 8, wherein N is at least 360 and each unit cell comprises an angular resolution of less than or equal to one degree.

15. A method for forming a spatially distributed depth sensor array, the method comprising:
forming a plurality of single photon avalanche photodiodes (SPADs) on a first wafer;
forming a plurality of time-to-digital converters (TDCs) on a second wafer;
forming a plurality of vertical cavity surface emitting lasers (VCSELs) on a third wafer;
singulating the SPADs, TDCs, and VCSELs; and
assembling, on a shared backplane, a plurality of unit cells in a 1×N array, each unit cell comprising a receive pixel comprising at least one SPAD vertically stacked over at least one TDC and a transmit pixel comprising at least one VCSEL.

16. The method of claim 15, wherein each unit cell comprises a short-range depth sensor having a range of less than 15 meters.

17. The method of claim 16, wherein each unit cell further comprises a field of view of at least 180 degrees and an angular resolution of less than 1 degree.

18. The method of claim 15, wherein a first subset of the unit cells has a first centerline-to-centerline pitch, and a second subset of the unit cells has a second centerline-to-centerline pitch.

19. The method of claim 18, wherein the first centerline-to-centerline pitch is between 1 and 10 mm.

20. The method of claim 15, wherein N is at least 360 and each unit cell comprises an angular resolution of less than or equal to one degree.
